(19) United States
(12) Patent Application Publication
(10) Pub. No.: US 2010/0080398 A1
(43) Pub. Date: Apr. 1, 2010

(54) METHOD AND SYSTEM FOR HEARING DEVICE FITTING

(75) Inventor: Bernd Waldmann, Maur (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 12/518,927

(22) PCT Filed: Dec. 13, 2006
(86) PCT No.: PCT/EP2006/069646

§ 371 Date: Jun. 12, 2009

(51) Int. Cl. H04B 3/20; H04R 25/00; H04R 31/00

(52) U.S. Cl. 381/66; 381/314; 29/594; 381/318

(57) ABSTRACT

The method for manufacturing an adjusted hearing device (1b) comprises the step of using first data (16a) obtained from a first hearing device (1a) adjusted to the preferences of a first user (5a) for adjusting a second hearing device (1b) of a second user (5b). This may comprise converting for compensating for differences between a hearing loss of said first user and a hearing loss of said second user and/or converting for compensating for differences between said first hearing device and said second hearing device. Preferably, said first data comprise fitting data (16). The system comprises a first hearing device (1a), a second hearing device (1b) and a converting system (15) operationally connectable to said first and said second hearing devices, adapted to converting first data (16a) from said first hearing device into second data (16b) for adjusting said second hearing device. Preferably, the system also comprises a communication link (7) between said first hearing device and said second hearing device. The invention allows different hearing device users to share their fitting data.

### TECHNICAL FIELD

The invention relates to the field of hearing devices, in particular to the field of fitting hearing devices. It relates to methods and apparatuses according to the opening clauses of the claims.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

### BACKGROUND OF THE INVENTION

Today's digital hearing devices have many parameters by means of which the acoustic performance of the hearing device can be adjusted to the preferences of a user. Such parameters are also referred to as fitting parameters.

Typically, such an adjusting of a hearing device, also referred to as fitting of a hearing device, is done by a hearing device fitter such as an audiologist. It has also been suggested that the user of the hearing device attempts to do the fitting by himself.

E.g., in the field of hearing-aid devices, as a first step in fitting a hearing-aid device, a so-called first fit is made. This is a rather rough fit, which only takes data into account, which are relatively easily determinable and/or can be determined in a rather straight-forward manner. Most importantly, data describing the user's hearing loss are determined, typically audiogram data. Further data, which frequently are considered for a first fit, are the age of the user, the user's gender and data describing if or how long the user has been using a hearing-aid device before and possibly, which type that former hearing-aid device was.

Using an algorithm, also referred to as fitting algorithm or fitting rationale, a first fit, more particularly, a first set of fitting parameters, is determined, based on the data mentioned above. Widely used examples for such algorithms are NAL-NL1, DSL-i/o and Phonak Digital. Some fitting parameters, in particular those which do not depend on the user's hearing loss, may be set to standard values for the first fit.

A first fit does usually not result in a fully satisfying hearing performance. A so-called fine-tuning will usually be done, which is based on the first fit and takes the user's listening experience into account. Accordingly, the user's individual preferences can much better be accounted for through the fine-tuning. The fine-tuning requires a lot of experience, so it is rather done by a professional hearing device fitter such as an audiologist. But the extent to which the fine-tuning can be optimized is limited by the amount of time the hearing device fitter can spend on this. The user himself, on the other hand, would be willing to spend a lot of time for the fine-tuning, but usually lacks the technical knowledge and experience required.

It is desirable to provide for an alternative way of fitting—in particular fine-tuning—a hearing device to the preferences of the hearing device user.

### SUMMARY OF THE INVENTION

Therefore, one object of the invention is to create an alternative way of adjusting a hearing device. A method for manufacturing an adjusted hearing device and a corresponding system shall be provided.

Another object of the invention is to provide for a system and a method, which do not have the disadvantages mentioned above.

Further objects emerge from the description and embodiments below.

At least one of these objects is at least partially achieved by methods and systems according to the patent claims.

The method for manufacturing an adjusted hearing device comprises the step of

a) using first data obtained from a first hearing device adjusted to the preferences of a first user for adjusting a second hearing device of a second user.

This allows said second user to benefit from adjustments and corresponding fitting parameter settings that have been found during fitting—preferably during fine-tuning—said first hearing device.

Said preferences of said first user are usually hearing preferences of said first user.

Said method for manufacturing an adjusted hearing device can also be circumscribed as a method for adjusting a hearing device.

In one embodiment, the method comprises the step of deciding if a conversion of said first data is required. If, e.g., said first hearing device is a different model than said second hearing device, it will usually be necessary to convert said first data before second data are obtained, which potentially provide for an improved hearing performance when used in said second hearing device of said second user. In case of technically identical first and second hearing devices, such conversion will usually not be required.

In one embodiment, the method comprises the step of deciding, which kind of conversion of said first data is required. Such a decision can be made, e.g., based on information about the make and/or model of said first and second hearing devices and on information about fitting parameters to which the first data relate. This allows to derive second data in a suitable form, which can allow said second hearing device to emulate at least a part of the fine-tuning applied to said first hearing device.

Typically, said first data are individual to said first user. More particularly, said first data are typically dependent on the first user's preferences, in particular the first user's hearing preferences.

Said first data can be dependent on a hearing loss of said first user or independent of a hearing loss of said first user. Possibly, a part of said first data are dependent on a hearing loss of said first user and another part is independent of a hearing loss of said first user.

In one embodiment, the method comprises the step of converting said first data in dependence of at least one of
a hearing loss of said first user; and
a hearing loss of said second user.

Said conversion allows to make use of said first data or data derived therefrom independent of a hearing loss of said first user and/or a hearing loss of said second user.

Said conversion may comprise at least one of
removing a dependence of said first data on a hearing loss of said first user; and
introducing a dependence on a hearing loss of said second user.

In particular, the method comprises the step of converting said first data for compensating for differences between a hearing loss of said first user and a hearing loss of said second user. Said conversion allows to make use of data derived from said first data, irrespective of the individual hearing losses of the first and second users.

In particular, if the first data relate to a gain model, such a conversion is very advantageous, because it allows to use fine-tuning results obtained for said first user for fine-tuning said second hearing device for said second user.

A gain model describes the basic amplification function of a hearing device, in dependence of input level and frequency.

In one embodiment, the method comprises the step of converting said first data for compensating for differences between said first hearing device and said second hearing device. Said differences are preferably differences which are independent of fitting parameter settings.

In particular, this method comprises the step of converting said first data for compensating for hardware differences between said first hearing device and said second hearing device.

And/or this method comprises, in particular, the step of converting said first data for compensating for software differences between said first hearing device and said second hearing device.

These embodiments enable a large number of hearing device users to share their fitting data, since users of different hearing device models, possibly even of different hearing device manufacturers, may share their fitting data with each other.

In one embodiment, said first data are related to at least one of
a gain model of said first hearing device;
a noise canceller of said first hearing device;
a feedback canceller of said first hearing device;
a reverberation canceller of said first hearing device;
an input unit of said first hearing device.

An input unit is or comprises at least one input transducer such as a microphone or a telephone coil.

In one embodiment, said first data are, more specifically, related to at least one of
a parameter of a gain model of said first hearing device;
a parameter of a noise canceller of said first hearing device;
a parameter of a feedback canceller of said first hearing device;
a parameter of a reverberation canceller of said first hearing device;
a parameter of an input unit of said first hearing device.

In one embodiment, the method comprises the step of transmitting said first data from said first hearing device to said second hearing device via a long-range communication network. This allows said first and second hearing devices to be located in locations remote from each other.

In one embodiment, said long-range communication network comprises the internet.

In one embodiment, the method comprises the step of storing said first data or data derived from said first data in a storage device external to said first and second hearing devices. This allows to have a copy of said first data, which can make it possible to recall said first data at a later point in time, while saving storage space in the first hearing device.

In one embodiment, said storage device comprises—for a multitude of users—data that have been obtained from hearing devices that have been adjusted to the preferences of their respective user. This allows to create a database containing the described data, from which a second user can select, which data he would like to use (possibly after some conversion) in his hearing device.

In one embodiment, the method comprises the step of transmitting said first data from said first hearing device to said second hearing device via a short-range communication network. This allows for a local transmission of said first data from said first hearing device to a close-by second hearing device, in particular a direct transmission of said first data from said first to said second hearing device. An exchange of first data during a meeting of said first and second users is enabled.

In one embodiment, said first data are complemented with data, which relate to at least one of
at least one fitting parameter of said first hearing device;
said first hearing device, in particular the make and/or the type of said first hearing device;
said first user, in particular a hearing loss of said first user;
an individual having adjusted said first hearing device to the preferences of said first user.

Such data can be referred to as data representing meta-information and will be referred to as complementing data.

If said complementing data relate to at least one fitting parameter of said first hearing device and/or said first hearing device, in particular the make and/or the type of said first hearing device, the interpretation of said first data is simplified. In particular, if and which type of conversion shall be applied, can easily be detected. Said complementing data related to at least one fitting parameter of said first hearing device can, e.g., describe this parameter and details of it.

If said complementing data relate to said first user or to said individual having adjusted said first hearing device, important information about the origin of said first data is given.

If said complementing data relate to a hearing loss of said first user, important information is given, which can be helpful for converting said first data. By means of such complementing data, said first data can be converted into data which are independent of the first user's hearing loss, which is of particular interest if said first data relate to a gain model. Accordingly, such complementing data can allow the generation of data, which can be easily used for adjusting a hearing device of another user, e.g., said second hearing device. Such complementing data can, e.g., be audiogram data of said first user.

In one embodiment, the method further comprises—after step a)—the step of undoing said adjusting of said second hearing device of step a). This is useful if said second user wants to try out new settings obtained from said first user. If the second user is not content with said new settings, he might want to re-install formerly-used settings. This embodiment allows the second user to re-adjust his hearing device and to return into a state his hearing device was in before step a) has been carried out. Such a returning to formerly-used settings may even be accomplished in an automated fashion, e.g., after a certain amount of time has passed, or after a prescribable number of switching-on and/or switching-off processes of the second hearing device.

In one embodiment, said first data comprise fitting data. It is a major concern of the invention to provide for a possibility for different hearing device users to share their fitting data, in particular their fine-tuning fitting data.

The system according to the invention comprises
a first hearing device;
a second hearing device;
a converting system operationally connectable to said first and said second hearing devices, adapted to converting first data from said first hearing device into second data for adjusting said second hearing device.

Usually, said first and second hearing devices are not identical: said second hearing device is different from said first hearing device. In particular, said first and second hearing devices are hearing devices of different users.

In one embodiment, the system comprises at least one of
a communication link between said first hearing device and said second hearing device;
a communication link between at least a part of said converting system and said first hearing device;
a communication link between at least a part of said converting system and said second hearing device.

Any of these communication links may involve at least one short-range communication connection and/or at least one long-range communication connection, e.g., e-mail connections, short-message-system connections (SMS), Bluetooth-connections, connections via the internet.

In one embodiment, at least a part of said converting system is comprised in at least one of said first and said second hearing devices.

In one embodiment, the system comprises a decision unit for deciding if a conversion of said first data is required and/or which conversion of said first data is required. This decision unit can be comprised in said converting system.

If, e.g., said first data can be used directly in said second hearing device, e.g., because said first and second hearing devices are of the same type, and version and said first data are independent of the first user's hearing loss, there will usually be no need for a conversion of said first data. If said first and second hearing devices are different versions of otherwise equal hearing devices and said first data are independent of the first user's hearing loss, there may be a conversion required for overcoming said difference in versions of said first and second hearing devices, whereas a conversion for making said first data independent of the first user's hearing loss will be superfluous.

In one embodiment, at least a part of said converting system is comprised in at least one of said first and said second hearing devices.

In one embodiment, the system comprises a processor external to said first and second hearing devices, and at least a part of said converting system is realized in form of program code executed in said processor.

In one embodiment, said system comprises a storage device external to said first and second hearing devices storing—for each of a multitude of users—data obtained from a hearing device adjusted to the preferences of a respective user of said multitude of users. Said storage device may, e.g., comprise a database of hearing device fitting parameter settings, in particular hearing device program settings, that have been created for different users, and which may be accessible by many hearing device users. Said storage device may furthermore be connectable to the internet, allowing many hearing device users to share their hearing device fitting parameters, e.g., using a chatroom software type or forum software type of software.

In one embodiment, the system comprises a computer system and program code for causing said computer system to perform at least one of the steps of
receiving said first data;
storing said first data or data derived from said first data in said storage device;
complementing said first data or data derived from said first data with additional data;
accomplishing at least a part of said conversion of said first data into said second data;
transmitting said first data or data derived from said first data, in particular said second data, towards said second hearing device;
displaying a user interface on a display, which allows to initiate at least one of the above-cited steps.

This program code can furthermore cause said computer system to allow a user of said computer system, in particular said second user, to choose, which of a multitude of data to transmit towards said second hearing device. It may furthermore allow a user of said computer system to add information to said first data, in particular on form of text, e.g., a rating (from said second user) of said first data, typically based on the achieved satisfaction regarding sound quality and/or hearing performance, and/or explicative comments (from said first user), typically related to the hearing preferences of said first user and/or to the acoustic environment in which said first data resulted in a satisfactory hearing performance or sound quality.

Preferably, said system according to the invention is a system for adjusting said second hearing device in dependence of adjustments done to said first hearing device, in particular in dependence of said first data from said first hearing device. Usually, said first hearing device is adapted to the preferences of a first user, and said second hearing device is a hearing device of a second user, which second user is different from said first user.

The advantages of the systems correspond to the advantages of corresponding methods.

Further preferred embodiments and advantages emerge from the dependent claims and the figures.

### BRIEF DESCRIPTION OF THE DRAWINGS

Below, the invention is described in more detail by means of examples and the included drawings. The figures show:

FIG. 1 a diagram illustrating a method according to the invention;

FIG. 2 a diagram illustrating a system according to the invention;

FIG. 3 a diagram illustrating a method and a system according to the invention;

FIG. 4 a diagram illustrating a system according to the invention;

FIG. 5 a diagram illustrating data used in the invention.

The reference symbols used in the figures and their meaning are summarized in the list of reference symbols. The described embodiments are meant as examples and shall not confine the invention.

### DETAILED DESCRIPTION OF THE INVENTION

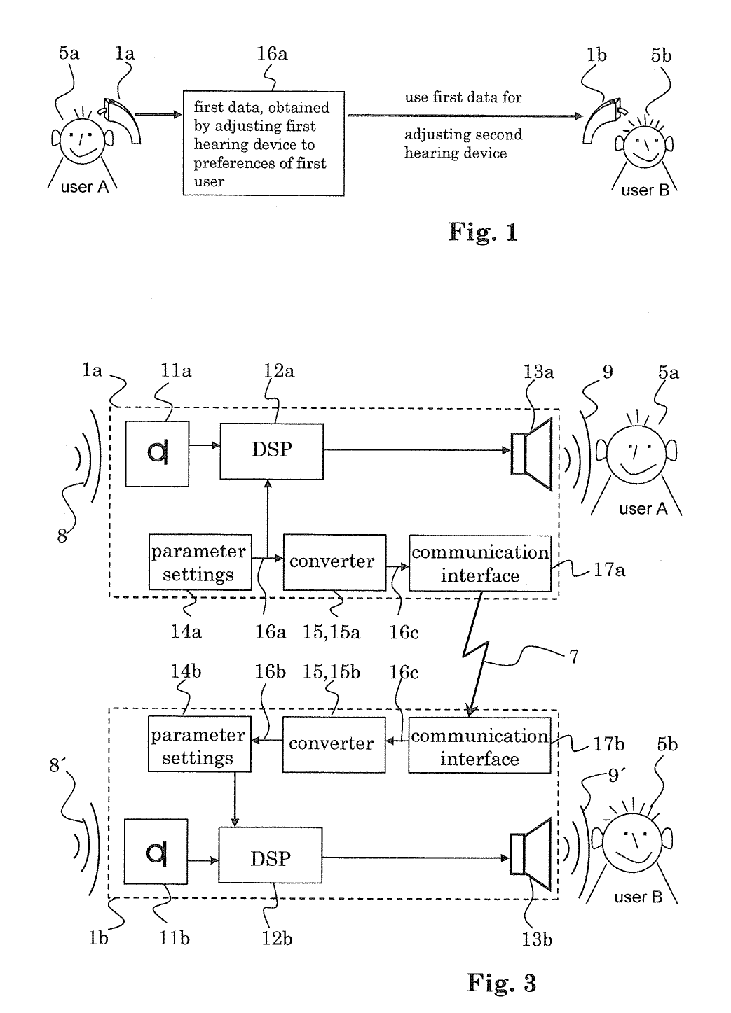

FIG. 1 shows a diagram illustrating a method according to the invention. A user 5a has a hearing device 1a, which is adjusted to his preferences. Data 16a obtained by adjusting hearing device 1a to the preferences of user 5a are used for adjusting another hearing device 1b of another user 5b. This allows, e.g., to use fitting parameter settings obtained during fine-tuning hearing device 1a to the preferences of user 5a for adjusting hearing device 1b, possibly resulting in an improved hearing performance for user 5b.

The method can be carried out, e.g., by user 5b or by users 5a and 5b. It is also thinkable that it is carried out by a hearing device fitter or by a hearing device fitter and at least one of users 5a and 5b.

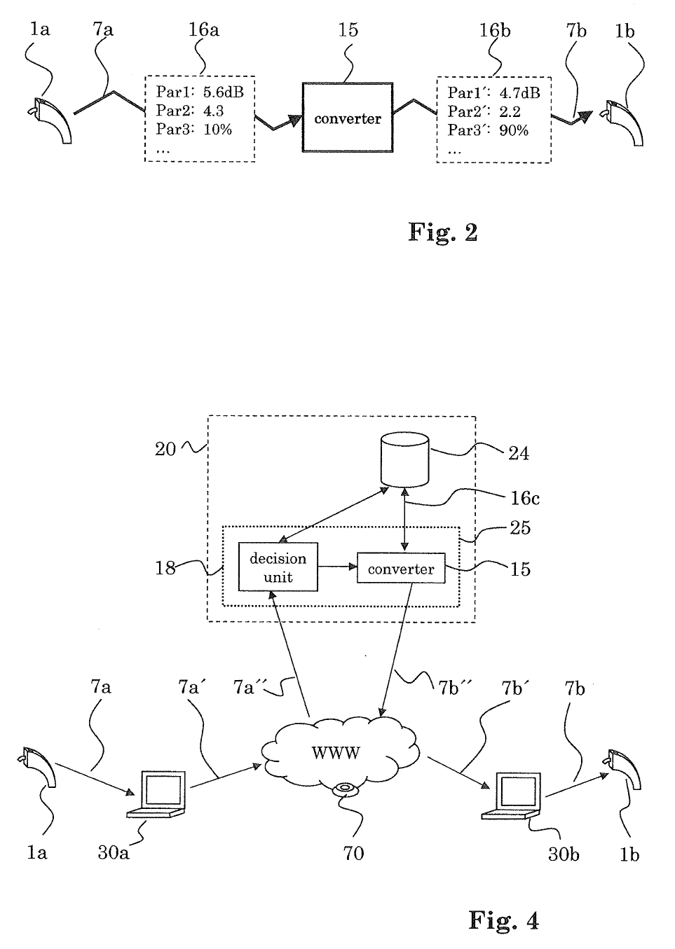

FIG. 2 shows a diagram illustrating a system according to the invention comprising two communication links 7a and 7b and a converter 15. The system may furthermore comprise hearing devices 1a and 1b. By means of communication link 7a, converter 15 is operationally connected to a hearing device 1a of a first user. By means of communication link 7b, converter 15 is operationally connected to a hearing device 1b of a second user.

Usually, said first and second users are different from each other and said hearing devices 1a,1b are worn by different users.

Data 16a transmitted via communication link 7a to converter 15 are converted into data 16b by converter 15. Data 16b are transmitted via communication link 7b to hearing device 1b.

Data 16a and 16b preferably comprise fitting parameter settings. Said conversion in converter 15 is typically done for compensating for at least one of
differences between a hearing loss of said first user and a hearing loss of said second user;
differences between said hearing device 1a and said hearing device 1b, in particular
   hardware differences between said hearing device 1a and said hearing device 1b and/or
   software differences between said hearing device 1a and said hearing device 1b.

In the example of FIG. 2, a setting of 5.6 dB for a Parameter 1 of hearing device 1a is converted into a setting of 4.7 dB for a Parameter 1′ of hearing device 1b corresponding to Parameter 1 of hearing device 1a. For further parameters, examples are given in FIG. 2.

It is immediately clear, that usually a conversion is required for different models of hearing devices 1a,1b, because different fitting parameters with differently defined ranges of values will usually be used in such hearing devices 1a,1b. If the meanings of the fitting parameters in both hearing devices 1a,1b are clear, it is easy to derive an algorithm that converts a setting of a fitting parameter of hearing device 1a into a setting of a corresponding fitting parameter of hearing device 1b or into settings or changes in settings of several fitting parameters of hearing device 1b. Note that—for a good conversion—it may be necessary to consider the setting of several fitting parameters of hearing device 1a for deriving a suitable setting for one or more fitting parameters of hearing device 1b. This depends on how the fitting parameters are defined in the hearing devices 1a,1b. Data 16a may be complemented with data related to such a definition of fitting parameters of hearing device 1a The converting may comprise, e.g., interpolating and extrapolating of values, limiting of values to a prescribable range, and others.

Preferably, a set of several fitting parameters, which describe a hearing program or at least a part of a hearing program, are converted in coverter 15 for deriving data 16b for adjusting hearing device 1b.

If data 16a relate to a gain model and depend on a hearing loss of user 5a, it will usually not be very meaningful to use such data 16a in an unchanged form for adjusting hearing device 1b, since usually, said hearing loss of user 5a will be different from a hearing loss of user 5b.

In this case, it is advisable to consider the hearing losses of users 5a and 5b in converting data 16a.

It can be very useful to extract the fine-tuning adjustments from data 16a and, accordingly, to remove what is dependent upon the hearing loss of user 5a. This can be accomplished by determining the deviation in fitting parameter settings between a first fit for user 5a and the state after fine-tuning hearing device 1a to the preferences of user 5a. Data describing this deviation are referred to as deviation data. Fitting parameter settings derived in a first fit for user 5a can be considered default settings for fitting hearing device 1a, wherein—when said default settings are related to a gain model—said default settings are typically settings of an objectively determined gain model. An objectively determined gain model is identical for users with identical hearing loss, wherein an identical hearing loss would be equivalent to identical audiograms of said users. Typically, said objectively determined gain model is a gain model obtained from a fitting algorithm. A fitting algorithm typically has audiogram data as input data, possibly complemented with other data like gender and age of the user.

For example, if data 16a comprise—in addition to the fitting parameter settings after fine-tuning—the fitting parameter settings after the first fit and before the fine-tuning (default settings), the deviation between the settings can be readily determined and used for adjusting hearing device 1b. Data representing said deviation could be applied to corresponding fitting parameters in hearing device 1b for implementing a corresponding deviation from current fitting parameter settings of hearing device 1b or from first-fit parameter settings of hearing device 1b.

In a more complicated case, which is likely to occur more frequently, only the fitting parameter settings after fine-tuning are available from hearing device 1a, but in addition, audiogram data of user 5a might be available, and also the fitting algorithm used for the first fit might be available. In this case, from the audiogram data, which describe the hearing loss of user 5a, and from the employed fitting algorithm used for the first fit, it is possible to determine the gain model derived for the first fit and, in addition, the deviation from the first-fit gain model, which has been introduced by the fine-tuning. Based on corresponding deviation data, it is possible to derive settings for hearing device 1b, which possibly lead to an improved hearing performance.

It is also possible that, in hearing device 1a, such deviation data are already stored, and/or that such deviation data are derivable within hearing device 1b.

There are several fitting parameters, which are likely to be independent of a hearing loss, e.g., noise canceller settings. Such fitting parameters will usually not require conversions as complicated as those discussed above for deriving deviation data in conjunction with gain models.

FIG. 3 shows a diagram illustrating a method and a system according to the invention. The system comprises a converting system 15 comprising two converters 15a,15b, which are operationally connected to each other. This operational connection comprises a short-range communication link 7.

The converters 15a,15b are comprised in hearing devices 1a and 1b, respectively, which can be considered part of the system. Hearing device 1a belongs to user 5a, hearing device 1b belongs to user 5b.

Only very basic features of the hearing devices 1a,1b are drawn in FIG. 3, so as to illustrate basic functions of the hearing devices 1a,1b. The hearing device 1a,1b may be quite different from each other, but in FIG. 3 they are drawn as having at least the same basic components, which are therefore explained only once, namely for hearing device 1a.

Hearing device 1a comprises, besides converter 15a, an input transducer unit 11a, a signal processing unit 12a, an output transducer unit 13a, a parameter storage unit 13a and a communication interface 17a.

Input transducer unit 11a receives input signals 8, typically acoustic sound or—e.g., when input transducer unit 11a comprises a telephone coil—electromagnetic waves, and transduces these into electrical signals of digital and/or analogue kind. Input transducer unit 11a typically comprises at least one microphone. Said electrical signals are processed in said signal processing unit 12a, which typically comprises a digital signal processor. The processed and typically also amplified electrical signals are then fed to an output transducer unit 13a, e.g., a loudspeaker, which generates signals 9 to be perceived by user 5a.

The signal processing can be controlled by parameter settings stored in parameter storage unit 14a. Such parameter settings can be used as first data 16a to be converted in conversion unit 15 for use, e.g., in hearing device 1b. It is possible to convert first data 16a only in converter 15a or only in converter 15b. In FIG. 3, both converter 15a,15b are used.

In converter 15a, first data 16a are converted into third data 16c, e.g., for bringing them into a standardized form and/or for removing from first data 16a dependencies upon a hearing loss of user 5a. The third data 16c are fed to communication interface 17a and transmitted to hearing device 11b, more precisely to communication interface 17b. Then, they are converted in converter 15b into second data 16b, which can be used as parameter settings for controlling signal processing unit 12b.

This way, two users 5a,5b can exchange fitting parameter settings. For example, if user 5a is very content with the performance of his feedback canceller, whereas user 5b is discontented with the way his feedback canceller works, user 5a may send his feedback canceller settings (represented by said third data) to user 5b (more precisely, hearing device 1b of user 5b). Then, user 5b can use parameter settings in his hearing device 1b, which emulate the settings user 5a is using, and either keep these settings or—if no improved hearing performance is achieved—return to his former settings. Said communication link 7 preferably involves another device of a hearing system to which one of the hearing devices 1a,1b belong, e.g., a remote control (not shown). Preferably, first data 16a—and therefore also data 16b and 16c—comprise a set of several fitting parameters, which describe a full hearing program or at least a part of a hearing program. The embodiment of FIG. 3 allows the exchange of fitting parameter settings directly from one user (user 5a) to another user (user 5b)—and vice versa.

FIG. 4 shows a diagram illustrating another system according to the invention. This system allows the transmission of fitting parameter settings over long distances and has a possibility to store such data external from the hearing devices 1a,1b.

The system comprises a converting system 15, which—together with an optional decision unit 18—is embodied in form of program code being executed in a processor 25. Preferably, processor 25 is part of a computer system 20, which preferably comprises a storage device 24 operationally connected to converting system 15. Via links 7a,7a′,7a″, converting system 15 (and processor 25) is operationally connectable to hearing device 1a of a first user, and via links 7b,7b′,7b″, converting system 15 (and processor 25) is operationally connectable to hearing device 1b of a second user. The links and/or at least one of the hearing devices 1a,1b may be part of the system.

As indicated in FIG. 4, long-range and/or short-range communication connections may be involved, e.g., short-range between a hearing device 1a/1b and a computer 30a/30b, and long-range—via the internet—between computer 30a/30b and computer system 20. On computer system 20, there may run a software, preferably an internet-based software, such as software of chat room or forum type, as they are commonly used in the internet.

This embodiment allows, e.g., for the following: The user of hearing device 1a wants to share some of his fine-tuning parameter settings and connects to the internet via his computer 30a. On a web-page of a hearing device manufacturer or of an independent institution, he uses a forum-type software with data loading capabilities by means of which he can upload data from his hearing device 1a via a Bluetooth connection 7a (or via an infrared or another preferably wireless connection) and via his computer 30a into said processor 25.

In the decision unit 18, it is checked whether a conversion of the uploaded data is required and, if yes, which type conversion has to be made. Third data 16c, which are derived from the uploaded data (with or without conversion), are stored in storage device 24, e.g., a hard disk. Preferably, the first user enters text in his computer, which gives comments and/or explanations concerning the uploaded data, and which is appended to the other uploaded data. Such text messages or other input can be considered data complementing uploaded fitting parameter settings. Such additional or complementing data can also be useful in the decision unit 18. The uploaded data comprising first data can be handled in the internet-based software as data files attached to said complementing data. Data in storage device 24 can be stored in a standardized way, which usually will require a conversion of uploaded data, but it is also possible to store uploaded data in storage device 24 without a conversion (preferably complemented with data describing the first user's hearing loss) or only with conversions for removing dependencies of the uploaded data from the hearing loss of the first user.

Many hearing device users may store fitting data in storage device 24 in the above-described way. This wealth of data may be organized in a database and may be accessible by many hearing device users.

Sooner or later, the owner of hearing device 1b (second user) will access the same internet site, looking for hearing program settings promising an improved hearing performance. From the data stored in storage device 24, he may choose, e.g., third data 16c to be downloaded to his hearing device 1b. Possibly, decision unit 18 will be involved for deciding about possibly required conversions. E.g., third data 16c could be converted for deriving data, which are adapted to the hearing loss of the second user.

The way for downloading data can be analogous to the way for uploading shown in FIG. 4 and described above.

Preferably, said downloaded (second) data are derived from uploaded (first) data of exactly one first user.

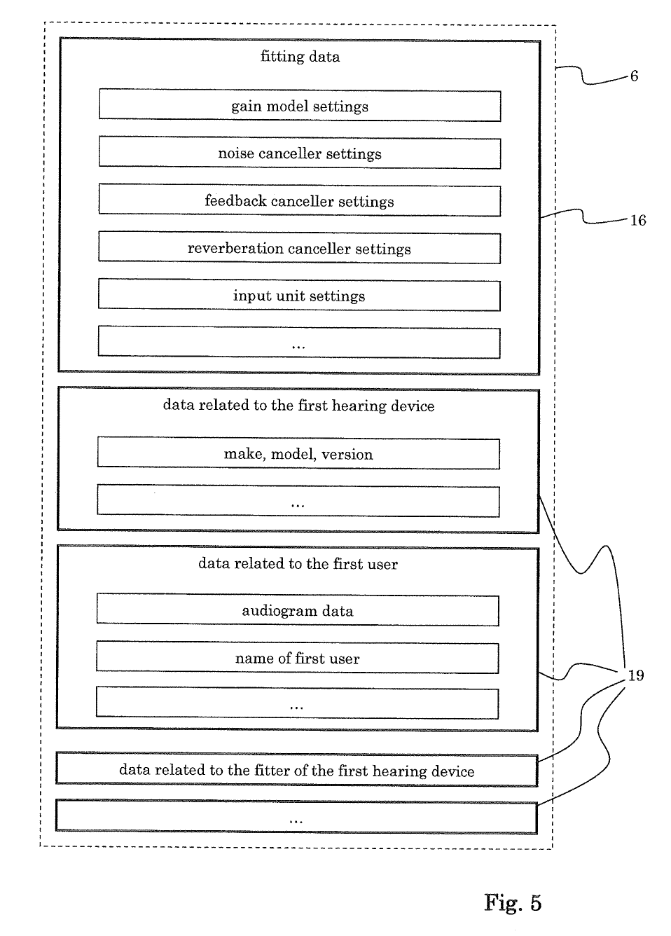

FIG. 5 shows a diagram illustrating exemplary data 6 that could be used in the invention. Data 6 comprise fitting data 16 and optional complementing data 19. The fitting data 16 may be first data, third data or second data. Data 6 can be uploaded data and/or data stored in storage device 24 and/or downloaded data.

Considered under a slightly different point of view, which emphasizes an adjustment of a hearing device by assigning values to fitting parameters, a method according to the invention can be circumscribed as a method for manufacturing a hearing device adjusted to the preferences of a user, wherein said hearing device has at least one fitting parameter and is adjustable by assigning a value to said at least one fitting parameter, said method comprising the step of assigning such a value to said at least one fitting parameter, which is derived from another value, which has been assigned to at least one other fitting parameter of another hearing device corresponding to said at least one fitting parameter upon adjusting said other hearing device to the preferences of another user.

### LIST OF REFERENCE SYMBOLS

1a,1b hearing device
5a,5b user
6 data
7,7a,7a′,7a″,7b,7b′,7b″ operational connection, communication link
8 input signals
9 output signals
11a,11b input unit, input transducer unit
12a,12b signal processing unit, digital signal processor
13a,13b output unit, output transducer unit
14a,14b parameter storage unit
15 converting system, converter
15a,15b converter, part of converting system
16 data, fitting data
16a first data
16b second data
16c third data
17a,17b communication interface
18 decision unit
19 complementing data
20 computer system, server
24 storage device
25 processor
30a,30b computer
70 long-range communication network, internet

What is claimed is:

1. Method for manufacturing an adjusted hearing device (1b), comprising the step of
a) using first data (16a) obtained from a first hearing device (1a) adjusted to the preferences of a first user (5a) for adjusting a second hearing device (1b) of a second user (5b).

2. The method according to claim 1, comprising the step of deciding if a conversion of said first data (16a) is required.

3. The method according to claim 1, comprising the step of deciding which kind of conversion of said first data (16a) is required.

4. The method according to claim 1, comprising the step of converting said first data (16a) in dependence of at least one of
a hearing loss of said first user (5a); and
a hearing loss of said second user (5b).

5. The method according to claim 1, comprising the step of converting said first data (16a) for compensating for differences between said first hearing device (1a) and said second hearing device (1b).

6. The method according to claim 5, comprising the step of converting said first data (16a) for compensating for hardware differences between said first hearing device (1b) and said second hearing device (1b).

7. The method according to claim 5, comprising the step of converting said first data (16a) for compensating for software differences between said first hearing device (1a) and said second hearing device (1b).

8. The method according to claim 1, wherein said first data (16a) are related to at least one of
a gain model of said first hearing device;
a noise canceller of said first hearing device;
a feedback canceller of said first hearing device;
a reverberation canceller of said first hearing device;
an input unit (11a) of said first hearing device.

9. The method according to claim 1, wherein said first data are related to at least one of
a parameter of a gain model of said first hearing device;
a parameter of a noise canceller of said first hearing device;
a parameter of a feedback canceller of said first hearing device;
a parameter of a reverberation canceller of said first hearing device;
a parameter of an input unit (11a) of said first hearing device.

10. The method according to claim 1, comprising the step of transmitting said first data (16a) from said first hearing device (1a) to said second hearing device (1b) via a long-range communication network (70).

11. The method according to claim 10, wherein said long-range communication network (70) comprises the internet.

12. The method according to claim 1, comprising the step of storing said first data (16a) or data derived from said first data in a storage device (24) external to said first and second hearing devices.

13. The method according to claim 12, wherein said storage device (24) comprises—for a multitude of users—data that have been obtained from hearing devices that have been adjusted to the preferences of their respective user.

14. The method according to claim 1, comprising the step of transmitting said first data (16a) from said first hearing device to said second hearing device via a short-range communication network.

15. The method according to claim 1, wherein said first data (16a) are complemented with data (19), which relate to at least one of
at least one fitting parameter of said first hearing device;
said first hearing device (1a), in particular the make and/or the type of said first hearing device;
said first user (5a), in particular a hearing loss of said first user;
an individual having adjusted said first hearing device to the preferences of said first user (5a).

16. The method according to claim 1, further comprising—after step a)—the step of undoing said adjusting of said second hearing device (1b) of step a).

17. The method according to claim 1, wherein said first data comprise fitting data.

18. System comprising
a first hearing device (1a);
a second hearing device (1b);
a converting system (15) operationally connectable to said first and said second hearing devices, adapted to converting first data (16a) from said first hearing device into second data (16b) for adjusting said second hearing device.

19. The system according to claim 18, comprising at least one of
a communication link (7) between said first hearing device and said second hearing device;
a communication link (7a) between at least a part of said converting system (15) and said first hearing device (1a);
a communication link (7b) between at least a part of said converting system (15) and said second hearing device (1b).

20. The system according to claim 19, wherein at least one of said communication links (7;7a;7b) comprises a communication link of a short-range communication network.

21. The system according to claim 19, wherein at least one of said communication links (7;7a;7b) comprises a communication link of a long-range communication network (70).

22. The system according to claim 18, wherein at least a part of said converting system (15) is comprised in at least one of said first and said second hearing devices.

23. The system according to claim 18, comprising a decision unit (18) for deciding if a conversion of said first data is required and/or which conversion of said first data is required.

24. The system according to claim 18, wherein said converting system (15) is adapted to converting said first data (16a) into said second data (16b) for compensating for differences between a hearing loss of said first user (5a) and a hearing loss of said second user (5b).

25. The system according to claim 18, wherein said converting system (15) is adapted to converting said first data (16a) into said second data (16b) for compensating for differences between said first hearing device (1a) and said second hearing device (1b).

26. The system according to claim 25, wherein said converting system (15) is adapted to converting said first data into said second data for compensating for hardware differences between said first hearing device and said second hearing device.

27. The system according to claim 25, wherein said converting system is adapted to converting said first data into said second data for compensating for software differences between said first hearing device and said second hearing device.

28. The system according to claim 18, wherein said first data (16a) are related to at least one of
a gain model of said first hearing device;
a noise canceller of said first hearing device;
a feedback canceller of said first hearing device;
a reverberation canceller of said first hearing device;
an input unit (11a) of said first hearing device.

29. The system according to claim 18, wherein said first data are related to at least one of
a parameter of a gain model of said hearing device;
a parameter of a noise canceller of said first hearing device;
a parameter of a feedback canceller of said first hearing device;
a parameter of a reverberation canceller of said first hearing device;
a parameter of an input unit (11a) of said first hearing device.

30. The system according to claim 18, comprising a processor (25) external to said first and second hearing devices, and wherein at least a part of said converting system is realized in form of program code executed in said processor (25).

31. The system according to claim 18, comprising a storage device (24) external to said first and second hearing devices storing—for each of a multitude of users—data obtained from a hearing device adjusted to the preferences of one of said multitude of users.

32. The system according to claim 18, wherein said first data are complemented with data, which relate to at least one of
at least one fitting parameter of said first hearing device;
said first hearing device (1a), in particular the make and/or the type of said first hearing device;
said first user (5a), in particular a hearing loss of said first user;
an individual having adjusted said first hearing device to the preferences of said first user.

33. The system according to claim 18, wherein said first data (16) comprise fitting data (16).

34. The system according to claim 18, comprising a computer system (20) and program code for causing said computer system to perform at least one of the steps of
receiving said first data (16a);
storing said first data or data derived from said first data in said storage device (24);
complementing said first data or data derived from said first data with additional data;
accomplishing at least a part of said conversion of said first data into said second data;
transmitting said first data or data derived from said first data, in particular said second data, towards said second hearing device (1b);
displaying a user interface on a display, which allows to initiate at least one of the above-cited steps.

35. System according to claim 18, which is a system for adjusting said second hearing device (1b) in dependence of adjustments done to said first hearing device (1a).

36. System according to claim 18, wherein said first hearing device (1a) is adapted to the preferences of a first user (5a), and wherein said second hearing device (1b) is a hearing device of a second user (5b), which second user is different from said first user.
